(19) United States
(12) Patent Application Publication
(10) Pub. No.: US 2026/0012919 A1
(43) Pub. Date: Jan. 8, 2026

(54) DETECTING, MONITORING, AND COMMUNICATING WITH UNMANNED AIRCRAFT SYSTEMS

(71) Applicant: Drone Protection, LLC, Del Mar, CA (US)

(72) Inventors: Wayne LEVY, Del Mar, CA (US); Aaron LOFSTROM, Del Mar, CA (US)

(73) Assignee: Drone Protection, LLC, Del Mar, CA (US)

(21) Appl. No.: 19/329,310

(22) Filed: Sep. 15, 2025

Related U.S. Application Data
(63) Continuation of application No. PCT/US2024/051076, filed on Oct. 11, 2024.
(60) Provisional application No. 63/543,661, filed on Oct. 11, 2023.

(51) Int. Cl. H04W 64/00; H04W 4/021; H04W 4/44

(52) U.S. Cl. CPC H04W 64/00; H04W 4/021; H04W 4/44

(57) ABSTRACT

Systems and methods for detecting, monitoring, and communicating with unmanned aircraft systems are provided. The system allows an individual to establish a desired perimeter. The system monitors communication signals from UA within proximity to determine if the UA encroaches within the desired perimeter. The system is configured to identify a UA within the desired perimeter and collect and store flight information about the UA. The system is configured to send a communication to the operator of the UA and is also configured to send a communication to appropriate authorities if desired.

### CROSS-REFERENCE TO RELATED APPLICATION(S)

This application is a continuation of International application No. PCT/US2024/051076, filed Oct. 11, 2024 entitled, “DETECTING, MONITORING, AND COMMUNICATING WITH UNMANNED AIRCRAFT SYSTEMS”, which claims priority to U.S. Provisional Application No. 63/543,661, filed on Oct. 11, 2023, both of which are incorporated herein by reference in their entirety and made part of this specification.

### BACKGROUND

### Field of the Invention

The present disclosure generally relates to unmanned aircraft (“UA”) and unmanned aircraft systems (“UAS”) and more specifically relates to identifying the presence of UAs and communicating with the operator of the UAS.

### Related Art

Unmanned aircraft systems are typically made up of three parts, namely the aircraft, the controller used by the person manipulating the flight controls of the aircraft, and the communication link between the aircraft and the controller. The unmanned aircraft is commonly referred to as a drone, unmanned aerial vehicle (“UAV”), or UA and may employ a fixed wing or rotor. The unmanned aircraft system is commonly referred to as a remotely piloted aircraft system (“RPAS”) or UAS.

UAS are increasing in popularity and many hobbyists and recreationists enjoy operating UAS for fun and also to generate content for social media. A growing problem with UAS is that the operator intentionally or accidentally files the UA over people in a private or public area and the proximity of the UA to the people is considered an invasion of privacy. Therefore, what is needed is a system and method that overcomes these significant problems described above.

### SUMMARY

The present disclosure provides systems and methods that address the significant problems associated with UAS that are increasingly being operated in proximity to individuals and businesses in public and private locations. The system operates to allow an individual in proximity to an unknown UA to identify the UA and capture flight data for the UA. The system also facilitates sending a message from the individual in proximity to the unknown UA to the operator of the UA. The system also facilitates reporting the UAS to the Federal Aviation Administration (“FAA”) or other authorities if conditions warrant such reporting.

In some aspects, the techniques described herein relate to a system including: a user device including: a wireless receiver configured to receive wireless communication signals from an unmanned aerial vehicle (UAV) in proximity to the user device; a non-transitory computer readable medium configured to store executable programmed modules; a processor communicatively coupled with the wireless receiver and the non-transitory computer readable medium, the processor configured to execute one or more programmed modules stored in the non-transitory computer readable medium to process a signal from the UAV received by the wireless receiver and identify the UAV; a server device including: a non-transitory computer readable medium configured to store executable programmed modules; a processor communicatively coupled with the non-transitory computer readable medium, the processor configured to execute one or more programmed modules stored in the non-transitory computer readable medium to process a signal received from the user device and identify an operator corresponding to the UAV and send a message to the operator of the UAV.

In some aspects, the techniques described herein relate to a user device including: a wireless receiver configured to receive wireless communication signals from an unmanned aerial vehicle (UAV) in proximity to the user device; a non-transitory computer readable medium configured to store executable programmed modules; a processor communicatively coupled with the wireless receiver and the non-transitory computer readable medium, the processor configured to execute one or more programmed modules stored in the non-transitory computer readable medium to: process a signal from the UAV received by the wireless receiver to identify the UAV; identify an operator corresponding to the UAV; and send a message to the operator of the UAV.

In some aspects, the techniques described herein relate to a system including at least one processor communicatively coupled with at least one non-transitory computer readable medium, wherein the at least one processor is programmed to: receive a wireless communication signal from an unmanned aerial vehicle (UAV); parse the wireless communication signal to obtain an identifier corresponding to the UAV; use the identifier to determine an operator of the UAV; obtain contact information for the operator of the UAV; and send a message to the operator of the UAV.

In some aspects, the techniques described herein relate to a method where one or more processors are programmed to perform steps including: receive a wireless communication signal from an unmanned aerial vehicle (UAV); parse the wireless communication signal to obtain an identifier corresponding to the UAV; use the identifier to determine an operator of the UAV; obtain contact information for the operator of the UAV; and send a message to the operator of the UAV.

In some aspects, the techniques described herein relate to a non-transitory computer readable medium having stored thereon one or more sequences of instructions for causing one or more processors to perform steps including: receive a wireless communication signal from an unmanned aerial vehicle (UAV); parse the wireless communication signal to obtain an identifier corresponding to the UAV; use the identifier to determine an operator of the UAV; obtain contact information for the operator of the UAV; and send a message to the operator of the UAV.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a block diagram illustrating an example prior art unmanned aircraft system according to an embodiment of the invention;

FIG. 2 illustrates an example communication infrastructure, in which one or more of the processes described herein, may be implemented, according to an embodiment;

FIG. 3 illustrates an example processing system, by which one or more of the processes described herein, may be executed, according to an embodiment;

FIG. 4 is a block diagram illustrating an example spherical radius perimeter according to an embodiment of the invention;

FIG. 5 is a block diagram illustrating another example spherical radius perimeter according an embodiment of the invention;

FIG. 6 is a block diagram illustrating an example unmanned aircraft system according to an embodiment of the invention;

FIG. 7 is a block diagram illustrating an example unmanned aircraft system according to an embodiment of the invention;

FIG. 8 is a flow diagram illustrating an example process for establishing a perimeter according to an embodiment of the invention;

FIG. 9 is a flow diagram illustrating an example process for monitoring a UA according to an embodiment of the invention;

FIG. 10 is a flow diagram illustrating an example process for communicating with an operator of a UA according to an embodiment of the invention;

FIG. 11 is a flow diagram illustrating an example process for communicating with a UA according to an embodiment of the invention;

FIG. 12 is a flow diagram illustrating an example process for communicating with a UA according to an embodiment of the invention; and

FIG. 13 is a flow diagram illustrating an example process for reporting flight data corresponding to a UAS according to an embodiment of the invention.

### DETAILED DESCRIPTION

Disclosed herein are systems, methods, and non-transitory computer-readable media for detecting, monitoring, and communicating with unmanned aircraft systems. For example, one method disclosed herein allows for a user device to identify a UA within a certain proximity of the user device and collect and store flight information corresponding to the UA. The method further allows the user to send a message to the operator of the UA and, if desired, to report the UA and its operator to the FAA or other authorities.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

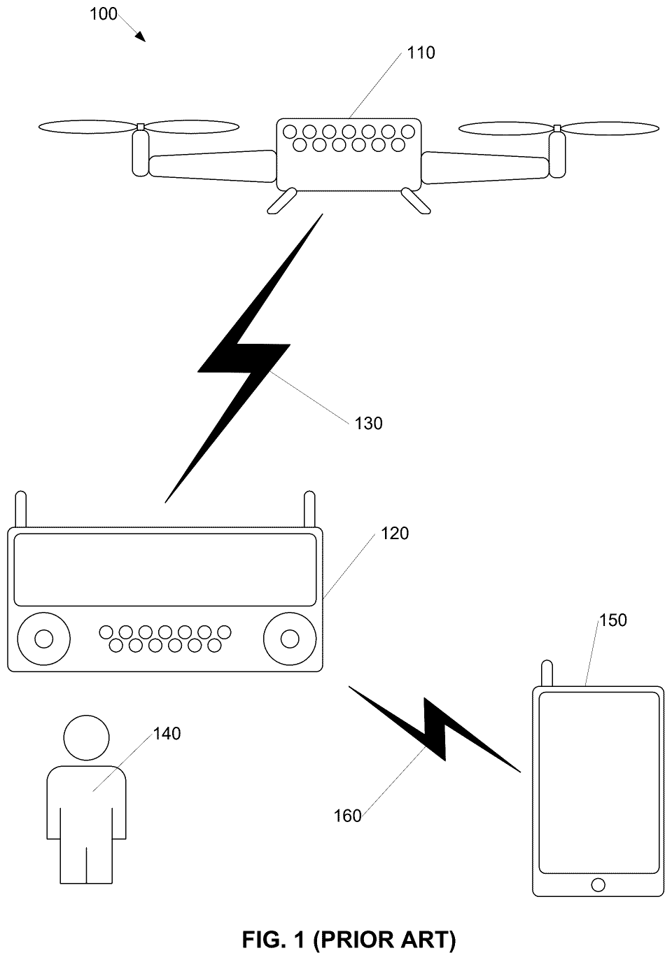

FIG. 1 is a block diagram illustrating an example prior art unmanned aircraft system 100 according to an embodiment of the invention. The prior art UAS 100 comprises a UA 110, a controller 120 and a communication link 130. The controller 120 is configured to be operated by a pilot 140 that uses the controller 120 to send flight commands to the UA 110 via the communication link 130. In one aspect, the pilot 140 may have a wireless communication device 150 that communicates with the controller 120 via a wired or wireless communication link 160.

### 1. System Overview

### 1.1. Infrastructure

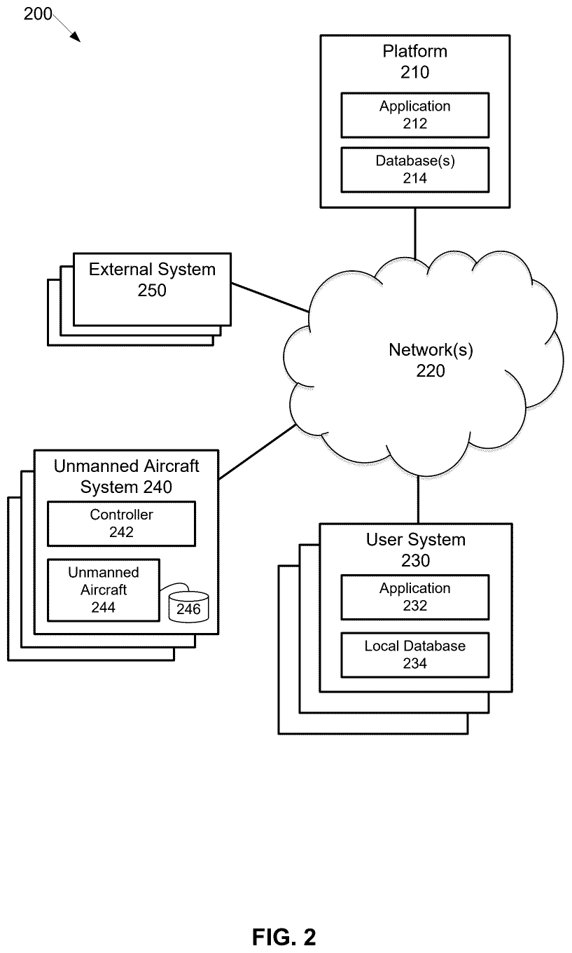

FIG. 2 illustrates an example infrastructure 200 in which one or more of the disclosed processes may be implemented, according to an embodiment. The infrastructure may comprise a platform 210 (e.g., one or more servers) which hosts and/or executes one or more of the various functions, processes, methods, and/or software modules described herein. Platform 210 may comprise dedicated servers, or may instead comprise cloud instances, which utilize shared resources of one or more servers. These servers or cloud instances may be collocated and/or geographically distributed. Platform 210 may also comprise or be communicatively connected to a server application 212 and/or one or more databases 214. In addition, platform 210 may be communicatively connected to one or more user systems 230 via one or more networks 220. Platform 210 may also be communicatively connected to one or more external systems 250 (e.g., other platforms, servers, websites, etc.) via one or more networks 220. In one embodiment, platform 210 may also be communicatively connected to one or more unmanned aircraft systems 240 via one or more networks 220.

Network(s) 220 may comprise the Internet, and platform 210 may communicate with user system(s) 230 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 210 is illustrated as being connected to various systems through a single set of network(s) 220, it should be understood that platform 210 may be connected to the various systems via different sets of one or more networks. For example, platform 210 may be connected to a subset of user systems 230 and/or external systems 250 via the Internet, but may be connected to one or more other user systems 230 and/or external systems 250 via an intranet. Furthermore, while only a few user systems 230 and external systems 250, one server application 212, and one set of database(s) 214 are illustrated, it should be understood that the infrastructure may comprise any number of user systems, external systems, server applications, and databases.

User system(s) 230 may comprise any type or types of computing devices capable of wired and/or wireless communication, including without limitation, desktop computers, laptop computers, tablet computers, smart phones or other mobile phones, home security systems, vehicle security systems, other security systems, servers, game consoles, head mounted displays, and the like. The user system 230 is configured to receive a wireless signal being broadcast by unmanned aircraft within signal range such as the UA 244.

Platform 210 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 210 transmits or serves one or more screens of the graphical user interface in response to requests from user system(s) 230. In some embodiments, these screens may be served in the form of a wizard, in which case two or more screens may be served in a sequential manner, and one or more of the sequential screens may depend on an interaction of the user or user system 230 with one or more preceding screens. The requests to platform 210 and the responses from platform 210, including the screens of the graphical user interface, may both be communicated through network(s) 220, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 214) that are locally and/or remotely accessible to platform 210. Platform 210 may also respond to other requests from user system(s) 230.

Platform 210 may further comprise, be communicatively coupled with, or otherwise have access to one or more database(s) 214. For example, platform 210 may comprise one or more database servers which manage one or more databases 214. A user system 230 or server application 212 executing on platform 210 may submit data (e.g., user data, form data, etc.) to be stored in database(s) 214, and/or request access to data stored in database(s) 214. Any suitable database may be utilized, including without limitation MySQL™, Oracle™, IBM™, Microsoft SQL™, Access™, PostgreSQL™, and the like, including cloud-based databases and proprietary databases. Data may be sent to platform 210, for instance, using the well-known POST request supported by HTTP, via FTP, and/or the like. This data, as well as other requests, may be handled, for example, by server-side web technology, such as a servlet or other software module (e.g., comprised in server application 212), executed by platform 210.

In embodiments in which a web service is provided, platform 210 may receive requests from external system(s) 250, and provide responses in extensible Markup Language (XML), JavaScript Object Notation (JSON), and/or any other suitable or desired format. In such embodiments, platform 210 may provide an application programming interface (API) which defines the manner in which user system(s) 230 and/or external system(s) 250 may interact with the web service. Thus, user system(s) 230 and/or external system(s) 250 (which may themselves be servers), can define their own user interfaces, and rely on the web service to implement or otherwise provide the backend processes, methods, functionality, storage, and/or the like, described herein. For example, in such an embodiment, a client application 232 executing on one or more user system(s) 230 may interact with a server application 212 executing on platform 210 to execute one or more or a portion of one or more of the various functions, processes, methods, and/or software modules described herein. Client application 232 may be “thin,” in which case processing is primarily carried out server-side by server application 212 on platform 210. A basic example of a thin client application 232 is a browser application, which simply requests, receives, and renders webpages at user system(s) 230, while server application 212 on platform 210 is responsible for generating the webpages and managing database functions. Alternatively, the client application may be “thick,” in which case processing is primarily carried out client-side by user system(s) 230. It should be understood that client application 232 may perform an amount of processing, relative to server application 212 on platform 210, at any point along this spectrum between “thin” and “thick,” depending on the design goals of the particular implementation. In any case, the application described herein, which may wholly reside on either platform 210 (e.g., in which case server application 212 performs all processing) or user system(s) 230 (e.g., in which case client application 232 performs all processing) or be distributed between platform 210 and user system(s) 230 (e.g., in which case server application 212 and client application 232 both perform processing), can comprise one or more executable software modules that implement one or more of the processes, methods, or functions of the application described herein.

Unmanned aircraft system 240 comprises a controller 242 and an unmanned aircraft 244 and a communication link between the controller 242 and the UA 244. In one embodiment, the communication link may be one or more networks 220 and in an alternative embodiment, the communication link may be direct wireless communication. As mentioned above, the controller 242 is configured to be operated by a pilot that uses the controller 242 to send flight commands to the UA 244 via the communication link 220.

External system(s) 250 may include a variety of different types of servers such as web servers and software-as-a-service servers and data storage servers and the like. External system(s) 250 may be owned and operated by third parties such as private individuals or entities, government entities, quasi-government entities, and the like. In one embodiment, external system 250 is operated by or on behalf of the FAA.

### 1.2. Example Processing Device

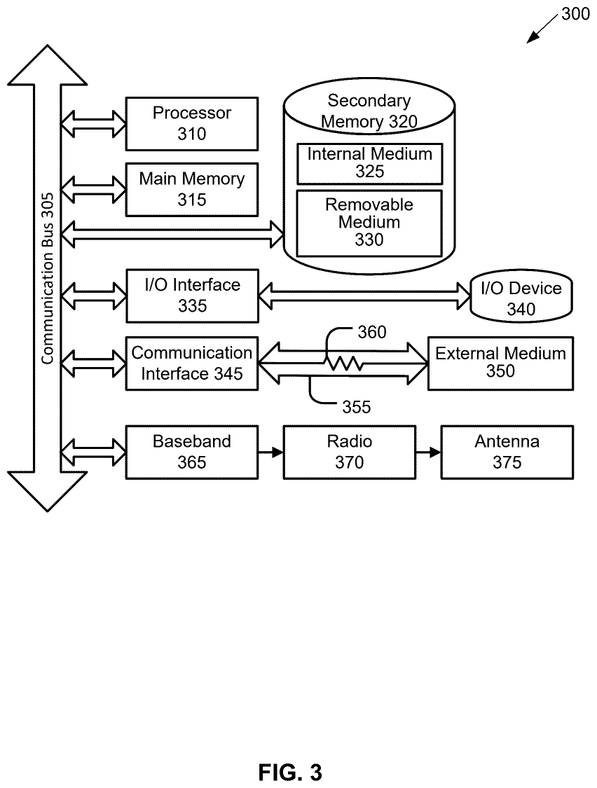

FIG. 3 is a block diagram illustrating an example wired or wireless system 300 that may be used in connection with various embodiments described herein. For example, system 300 may be used as or in conjunction with one or more of the functions, processes, or methods (e.g., to store and/or execute the application or one or more software modules of the application) described herein, and may represent components of platform 210, user system(s) 230, controller 242 and UA 244 of the UAS 240, external system(s) 250, and/or other processing devices described herein. System 300 can be a server or any conventional personal computer, or any other processor-enabled device that is capable of wired or wireless data communication. Other computer systems and/or architectures may be also used, as will be clear to those skilled in the art.

System 300 preferably includes one or more processors, such as processor 310. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 310. Examples of processors which may be used with system 300 include, without limitation, the Pentium® processor, Core i7® processor, and Xeon® processor, all of which are available from Intel Corporation of Santa Clara, California.

Processor 310 is preferably connected to a communication bus 305. Communication bus 305 may include a data channel for facilitating information transfer between storage and other peripheral components of system 300. Furthermore, communication bus 305 may provide a set of signals used for communication with processor 310, including a data bus, address bus, and/or control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 300 preferably includes a main memory 315 and may also include a secondary memory 320. Main memory 315 provides storage of instructions and data for programs executing on processor 310, such as one or more of the functions and/or modules discussed herein. It should be understood that programs stored in the memory and executed by processor 310 may be written and/or compiled according to any suitable language, including without limitation C/C++, Java, JavaScript, Perl, Visual Basic, .NET, and the like. Main memory 315 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 320 may optionally include an internal medium 325 and/or a removable medium 330. Removable medium 330 is read from and/or written to in any well-known manner. Removable storage medium 330 may be, for example, a magnetic tape drive, a compact disc (CD) drive, a digital versatile disc (DVD) drive, other optical drive, a flash memory drive, and/or the like. Secondary memory 320 is a non-transitory computer-readable medium having computer-executable code (e.g., disclosed software modules) and/or other data stored thereon. The computer software or data stored on secondary memory 320 is read into main memory 315 for execution by processor 310.

In alternative embodiments, secondary memory 320 may include other similar means for allowing computer programs or other data or instructions to be loaded into system 300. Such means may include, for example, a communication interface 345, which allows software and data to be transferred from external storage medium 350 to system 300. Examples of external storage medium 350 may include an external hard disk drive, an external optical drive, an external magneto-optical drive, and/or the like. Other examples of secondary memory 320 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 300 may include a communication interface 345. Communication interface 345 allows software and data to be transferred between system 300 and external devices (e.g. printers), networks, or other information sources. For example, computer software or executable code may be transferred to system 300 from a network server (e.g., platform 110) via communication interface 345. Examples of communication interface 345 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 300 with a network (e.g., network(s) 220) or another computing device. Communication interface 345 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 345 are generally in the form of electrical communication signals 360. These signals 360 may be provided to communication interface 345 via a communication channel 355. In an embodiment, communication channel 355 may be a wired or wireless network (e.g., network(s) 220), or any variety of other communication links. Communication channel 355 carries signals 360 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 315 and/or secondary memory 320. Computer programs can also be received via communication interface 345 and stored in main memory 315 and/or secondary memory 320. Such computer programs, when executed, enable system 300 to perform the various functions of the disclosed embodiments as described elsewhere herein.

In this description, the term “computer-readable medium” is used to refer to any non-transitory computer-readable storage media used to provide computer-executable code and/or other data to or within system 300. Examples of such media include main memory 315, secondary memory 320 (including internal memory 325, removable medium 330, and external storage medium 350), and any peripheral device communicatively coupled with communication interface 345 (including a network information server or other network device). These non-transitory computer-readable media are means for providing executable code, programming instructions, software, and/or other data to system 300.

In an embodiment that is implemented using software, the software may be stored on a computer-readable medium and loaded into system 300 by way of removable medium 330, I/O interface 335, or communication interface 345. In such an embodiment, the software is loaded into system 300 in the form of electrical communication signals 360. The software, when executed by processor 310, preferably causes processor 310 to perform one or more of the processes and functions described elsewhere herein.

In an embodiment, I/O interface 335 provides an interface between one or more components of system 300 and one or more input and/or output devices 340. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), head mounted displays (HMDs), and/or the like. In some cases, an input and output device 340 may be combined, such as in the case of a touch panel display (e.g., in a smartphone, tablet, or other mobile device).

In an embodiment, the I/O device 340 may be any type of external or integrated display and may include one or more discrete displays that in aggregate form the I/O device 340. The I/O device 340 may be capable of 2D or 3D presentation of visual information to a user of the system 300. In one embodiment, the I/O device 340 may be a virtual reality or augmented reality device in the form of HMD by the user so the user may visualize the presentation of information in 3D.

System 300 may also include optional wireless communication components that facilitate wireless communication over a voice network and/or a data network (e.g., in the case of user system 230). The wireless communication components comprise an antenna system 375, a radio system 370, and a baseband system 365. In system 300, radio frequency (RF) signals are transmitted and received over the air by antenna system 375 under the management of radio system 370.

In an embodiment, antenna system 375 may comprise one or more antennae and one or more multiplexors (not shown) that perform a switching function to provide antenna system 375 with transmit and receive signal paths. In the receive path, received RF signals can be coupled from a multiplexor to a low noise amplifier (not shown) that amplifies the received RF signal and sends the amplified signal to radio system 370.

In an alternative embodiment, radio system 370 may comprise one or more radios that are configured to communicate over various frequencies. For example, the radio system 370 may be configured to communication with a local device (not shown), a local base station (not shown), and/or a satellite (not shown) and communication with each such device may employ a different frequency and/or a different radio. In an embodiment, radio system 370 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 370 to baseband system 365.

If the received signal contains audio information, then baseband system 365 decodes the signal and converts it to an analog signal. Then the signal is amplified and sent to a speaker. Baseband system 365 also receives analog audio signals from a microphone. These analog audio signals are converted to digital signals and encoded by baseband system 365. Baseband system 365 also encodes the digital signals for transmission and generates a baseband transmit audio signal that is routed to the modulator portion of radio system 370. The modulator mixes the baseband transmit audio signal with an RF carrier signal, generating an RF transmit signal that is routed to antenna system 375 and may pass through a power amplifier (not shown). The power amplifier amplifies the RF transmit signal and routes it to antenna system 375, where the signal is switched to the antenna port for transmission.

Baseband system 365 is also communicatively coupled with processor 310, which may be a central processing unit (CPU). Processor 310 has access to data storage areas 315 and 320. Processor 310 is preferably configured to execute instructions (i.e., computer programs, such as the disclosed application, or software modules) that can be stored in main memory 315 or secondary memory 320. Computer programs can also be received from baseband processor 360 and stored in main memory 310 or in secondary memory 320, or executed upon receipt. Such computer programs, when executed, enable system 300 to perform the various functions of the disclosed embodiments.

### 1.3. Example Operation

Referring back to FIG. 2, within the infrastructure 200, the system is configured to operate such that the application 232 is configured to establish a spherical perimeter radius. The user system 230 includes a wireless receiver configured to receive a signal from the UA 244. The user system 230 processes the signal from the UA 244 to determine a distance between the UA 244 and the user system 230 and if the distance is equal to or shorter than the established spherical radius, the application 232 is configured to initiate the sending of a message to the UA 244.

To initiate the sending of the message, in one aspect, the application 232 may send a message to the platform 210. The message to the platform 210 includes a unique identifier for the UA 244 that the application 232 obtained from the signal that was received from the UA 244. In turn, the platform 244 may consult its local database 214 to obtain information about the UAS 240 including contact information for the operator of the UAS 240. Alternatively, the platform 244 may request information about the UAS 240 including contact information for the operator of the UAS 240 from external system 250. In one aspect, external system 250 may be a server maintained by the FAA and configured to provide information corresponding to uniquely identified UAs such as UA 244. Once the platform 210 has obtained the contact information for the operator of the UA 244, the application 212 is configured to send a message to the operator of the UA 244, for example, a message indicating that the UA 244 is too close to a person, an object, a facility, or some other item corresponding to the user system 230.

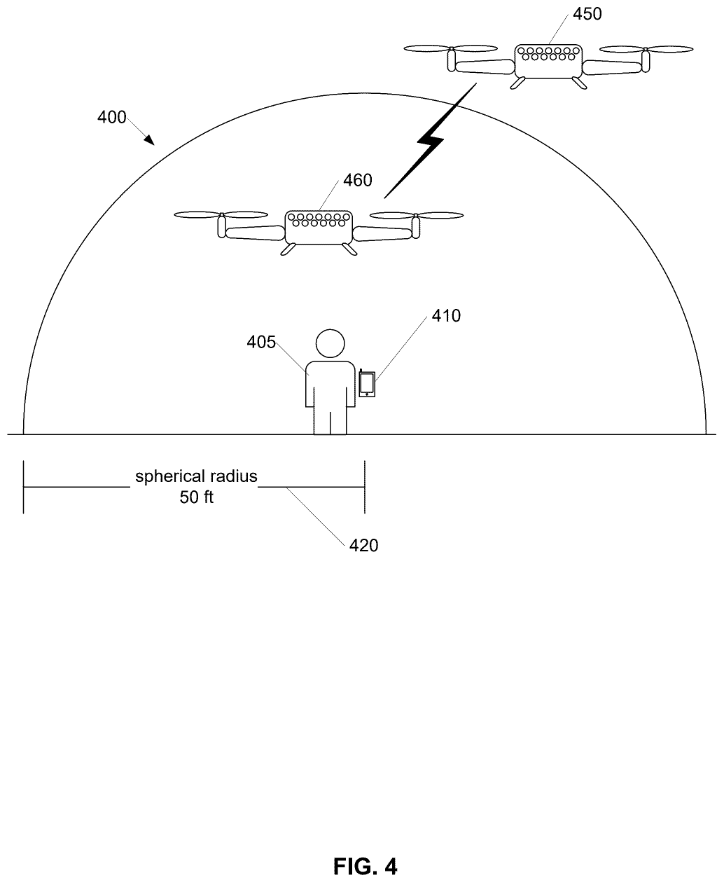

FIG. 4 is a block diagram illustrating an example spherical radius perimeter 400 according to an embodiment of the invention. In alternative embodiments, the perimeter 400 may have an alternative shape that is not spherical. For example, the perimeter 400 may be defined by a polygonal (or other shaped) geofence surrounding the user system 410, extending upward from the ground to a predetermined distance above the ground. For the sake of simplicity, the perimeter 400 will be discussed herein as a spherical shape, but the perimeter may alternatively be any sort of regular or irregular shape that defines a region surrounding the user system 410.

In the illustrated embodiment, a user system 410 (e.g., a wireless communication device associated with a person 405) is located at a center point that defines the spherical radius perimeter 400. In one aspect, the user system 410 operates to define the center point of the spherical radius perimeter 400. As shown in the illustrated embodiment, the radius 420 of the spherical perimeter 400 is 50 feet. Alternative distances can also be used as the radius 420 of the spherical perimeter 400. In one aspect, the radius 420 may be selected by the operator of the user system 410 to set the distance for the radius 420. Advantageously, the user system 410 is configured to receive a signal from UAV 450 and UAV 460 and process the signal to determine a distance between the user system 410 and the UAV 450 and a distance between the user system 410 and the UAV 460.

In a case where the distance between the user system 410 and the UAV 450 exceeds the radius of the spherical perimeter, the user system 410 is configured to take no action. In a case where the distance between the user system 410 and the UAV 460 is less than the radius of the spherical perimeter, the user system 410 is configured to take an action. For example, the user system 410 may be configured to parse the signal to identify the UA and use the identify of the UA to determine contact information for the operator of the UA and use the contact information to send a message to the operator of the UA. In one aspect, the message to the operator is a warning that the UA is too close to the person and needs to move away.

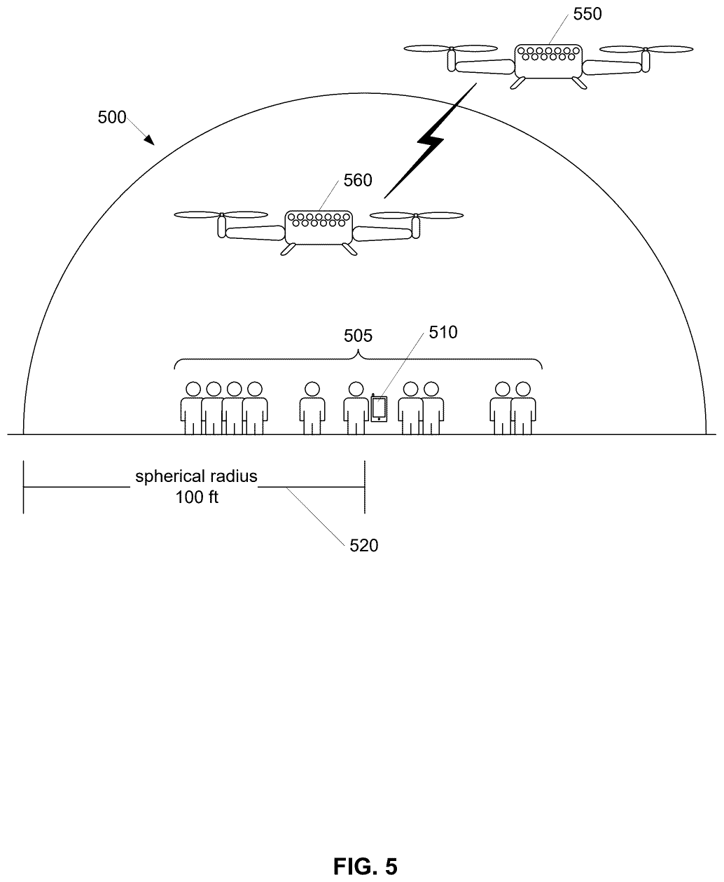

FIG. 5 is a block diagram illustrating another example spherical radius perimeter 500 according an embodiment of the invention. In alternative embodiments, the perimeter 500 may have an alternative shape that is not spherical. For example, the perimeter 500 may be defined by a polygonal (or other shaped) geofence surrounding the user system 510, extending upward from the ground to a predetermined distance above the ground. For the sake of simplicity, the perimeter 500 will be discussed herein as a spherical shape, but the perimeter may alternatively be any sort of regular or irregular shape that defines a region surrounding the user system 510.

In the illustrated embodiment, a user system 510 (e.g., a wireless communication device associated with a person who is part of a group 505) is located at a center point that defines the spherical radius perimeter 500. In one aspect, the user system 510 operates to define the center point of the spherical radius perimeter 500.

As shown in the illustrated embodiment, the radius 520 of the spherical perimeter 500 is 100 feet. Alternative distances can also be used as the radius 520 of the spherical perimeter 500. In one aspect, the radius 520 may be selected by the operator of the user system 510 to set the distance for the radius 520. For example, depending on the size of the group of people, in order to maintain a minimum distance of, e.g., 50 feet from any one person in the group, the spherical radius 500 may be set to 100 feet or 150 feet.

Advantageously, the user system 510 is configured to receive a signal from UAV 550 and UAV 560 and process the signal to determine a distance between the user system 510 and the UAV 550 and a distance between the user system 510 and the UAV 560. In a case where the distance between the user system 510 and the UAV 550 exceeds the radius of the spherical perimeter, the user system 510 is configured to take no action.

Alternatively, in a case where the distance between the user system 510 and the UAV 560 is less than the radius of the spherical perimeter, the user system 510 is configured to take an action. For example, the user system 510 may be configured to parse the signal to identify the UA and use the identity of the UA to determine contact information for the operator of the UA and use the contact information for the operator of the UA to send a message to the operator of the UA. In one aspect, the message to the operator is a warning that the UA is too close to the group 560 of people and needs to move away.

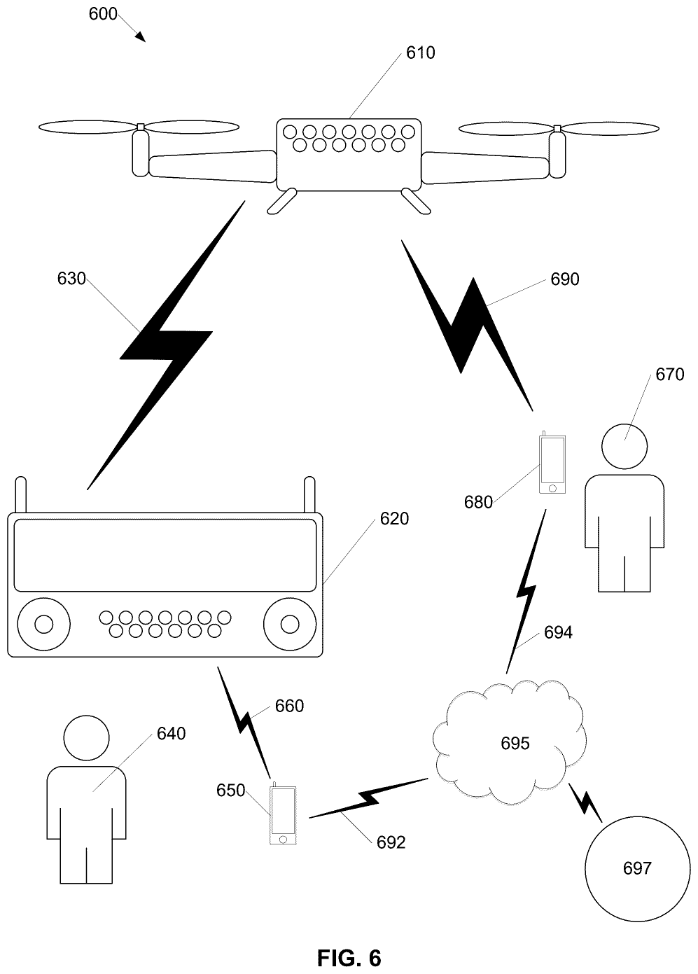

FIG. 6 is a block diagram illustrating an example unmanned aircraft system 600 according to an embodiment of the invention. In the illustrated embodiment, the UAS 600 includes a UA 610 and a controller 620 that is configured to wireless communicate with the UA 610 via a wireless communication link 630. In one aspect, the controller 620 communicates with the UA 610 via separate video and control channels, for example, a video communication channel may use a 5 GHz bandwidth while a control channel may use a 2.4 GHz bandwidth. An operator 640 interacts with the controller 620 to provide instructions to the UA 610. The operator 640 may also employ a user system 650 that is configure to communication the controller 620 via a wired or wireless communication link 660. Separately, a user 670 has a corresponding user system 680 that is configured to receive wireless communication signals from the UA 610 via a wireless communication link 690. In one aspect, the user system 680 may also be configured to send wireless communication signals to the drone via the wireless communication link 690. The user system 680 is configured to process the wireless communication signals received from the UA 610 to determine a distance between the UA 610 and the user system 680. The user system 680 is also configured to determine if the distance between the UA 610 and the user system 680 exceeds a predetermine threshold, for example, 50 feet or 100 feet.

In one aspect, the user system 680 has a wireless receiver that receives a signal from the UA 610 and the user system 680 executes an application that processes the signal from the UA 610 to determine an estimated distance between the user system 680 and the UA 610. Because the UA 610 is in flight and may be hovering or may be moving, the application may be configured to analyze a plurality of signals from the UA 610 to estimate an average distance between the UA 610 and the user system 680. The application may also be configured to determine a closest distance between the UA 610 and the user system 680 and a further distance between the UA 610 and the user system 680, for example, during a particular time period in which a closest distance exceeds the threshold, such as 5 minutes before and 5 minutes after a time at which the distance exceeds the threshold.

If the user system 680 determines that the distance between the UA 610 and the user system 680 exceeds the threshold, which may, for example, be a spherical radius surrounding the user system 680, the user system 680 is configured to initiate a notification to the UA 610, or to the operator 640 who controls the UA 610, or to the operator's user system 650 that may communicate the message to the UA 610 via the controller 620. In one aspect, the user system 680 executes an application to initiate the notification to the UA 610. For example, the application may send a message to a server 697 via a wireless communication link 694 and a network 695. The message may advantageously include an identifier that uniquely identifies the UA 610. In one aspect, the unique identifier for the UA 610 may be parsed by the user system 680 from the wireless signal received from the UA 610. Advantageously, the user system 680 sends the message to the server 697 and the server 697 obtains contact information for the operator of the UA 610. For example, the server 697 may have a local database of UASs that includes contact information for the operator of the UA. Alternatively, the server 697 may contact a different server (not shown) to obtain the contact information for the operator of the UA 610. Once the contact information for the operator of the UA 610 has been obtained by the server 697, the server 697 is configured to send a message to the user system 650 of the operator of the UA 610. The message from the server 697 can be sent via the network 695 and a wireless communication link 692 between the network 695 and the user system 650. In one aspect, the message from the server 697 to the user system 650 of the operator of the UA 610 may inform the operator of the UA 610 that the UA 610 is too close to the user 670 (or to some other person or facility or object).

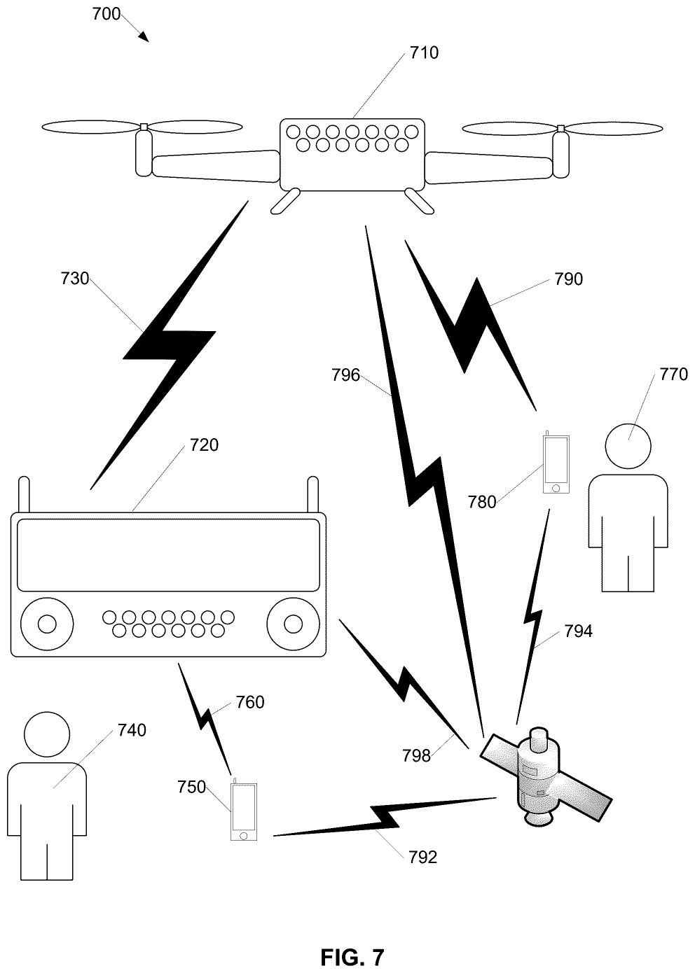

FIG. 7 is a block diagram illustrating an example unmanned aircraft system 700 according to an embodiment of the invention. The system 700 is similar to the system 600 previously described with respect to FIG. 6 and therefore only those aspects of FIG. 7 that differ from the previous description will be described with respect to FIG. 7.

More specifically, if the user system 780 determines that the distance between the UA 710 and the user system 780 exceeds the threshold, which may, for example, correspond to a spherical radius surrounding the user system 780, the user system 780 is configured to initiate a notification to the UA 710. In one aspect, the user system 780 executes an application to initiate the notification to the UA 710. The notification to the UA 710 may be sent directly or indirectly.

For example, the application may send a message directly to the UA 710 via the communication link 790. Alternatively, the application may send a message indirectly to the UA 710 via a satellite 795 that the user system 780 communicates with via a communication link 794. The satellite 795, in turn, may communicate directly with the UA 710 via a communication link 796. The satellite 795 may also communicate directly with the controller 720 via communication link 798 and the controller 720, in turn, communicates directly with the UA 710 via a communication link 730. The satellite 795 may also communicate directly with the user system 750 (e.g., the operator 740's user system) via communication link 792 and the user system 750 communicates directly with the controller 720 via communication link 760 and the controller 720, in turn, communicates directly with the UA 710 via a communication link 730. The satellite 795 may also communicate directly with the user system 750 (e.g., the operator 740's user system) via communication link 792 and the user system 750 provides a message to operator 740 via a user interface and the operator 740 enters commands into the controller 720 and the controller 720 communicates directly with the UA 710 via a communication link 730.

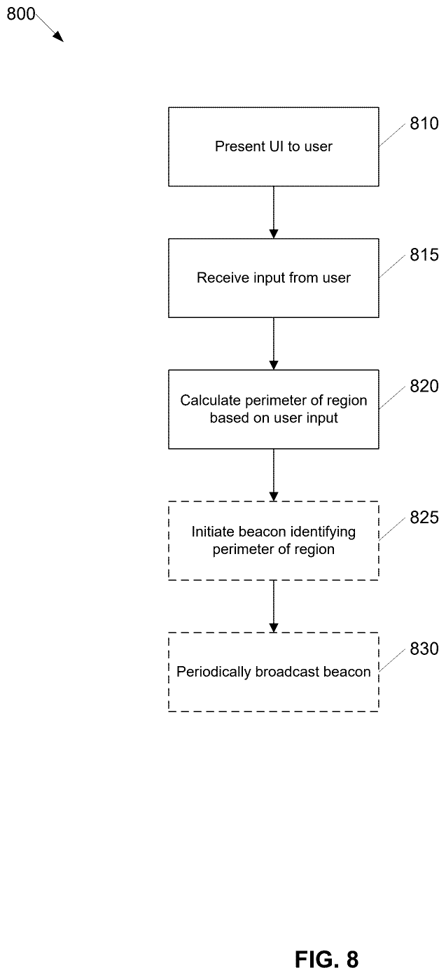

FIG. 8 is a flow diagram illustrating an example process 800 for establishing a perimeter according to an embodiment of the invention. In one aspect, the process of FIG. 8 may be carried out by the system described with respect to FIG. 2, 6, or 7 in combination with one or more processing devices described with respect to FIG. 3, for example, the process 800 may be carried out by an application 232 executing on a user system 230.

Initially, at 810 the user system presents a user interface to a user. The user interface may have a text entry field or a voice to text entry capability, or some other user interface field or capability that facilitates receiving an input from a user. At 815, the user system receives the input from the user and at 820 the user system calculates the perimeter of the region surrounding the user system based on the user input. In one aspect, the user may enter a radius value and the user system calculates a sphere having a central point at a location of the user system. For example, the user may enter a value of 50 and the user system may calculate a sphere having a radius of 50 feet (or 50 meters) and use the latitude and longitude values for the current location of the user system to determine a 50 foot sphere around the user system. In one aspect, the user system may approximate the sphere by estimating that the user system is on a flat surface and that only half of the sphere around the user system is available for a UA to occupy because the other half of the sphere is underground.

In another aspect, the user may enter a street address and a height value of 200 feet and the user system calculates a polygon having a perimeter based on a parcel boundary associated with the street address and extending upward into the sky 200 feet (or 200 meters), in accordance with the distance of the height value.

Additionally, at 825 the user system may optionally initiate the sending of a beacon signal that includes an identification of the perimeter of the region around the user system. In one aspect, the region around the user system may be identified by providing a center point using latitude and longitude coordinates or global positioning system (GPS) coordinates and a radius that can be used to define a spherical region. In another aspect, the region around the user system may be identified by providing a geofence region on the ground (e.g., using latitude and longitude coordinates or global positioning system (GPS) coordinates) and a height value that can be used to define a regular or irregular region surrounding the user system. This allows a UA, in certain circumstances, to determine if the UA is within the region. This also allows a UA, in certain circumstances, to avoid flying into the region identified by the user system. Advantageously, the user system may optionally be configured to periodically broadcast the beacon signal, as shown at 830, so that any UA within range of receiving the beacon signal may exit the sphere around the user system or avoid flying into the sphere around the user system.

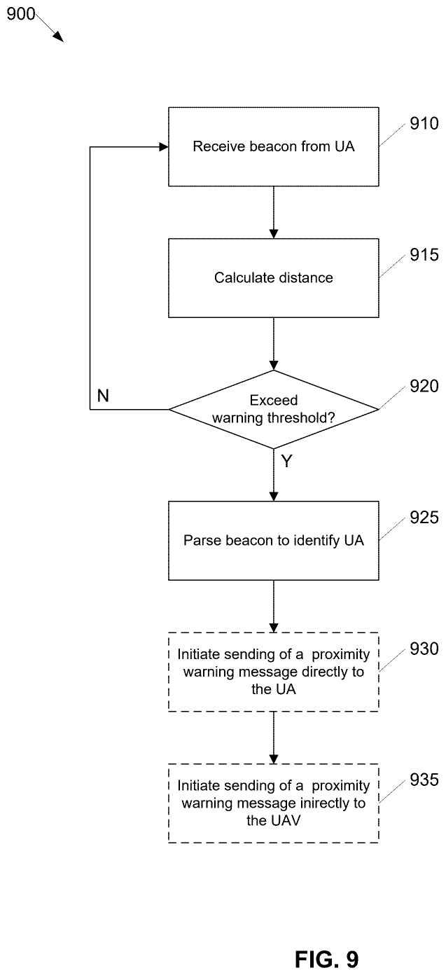

FIG. 9 is a flow diagram illustrating an example process 900 for monitoring a UA according to an embodiment of the invention. In one aspect, the process of FIG. 9 may be carried out by the system described with respect to FIG. 2, 6, or 7 in combination with one or more processing devices described with respect to FIG. 3, for example, the process 900 may be carried out by an application 232 executing on a user system 230.

Initially, at 910, the user system receives a beacon signal being broadcast by the UV. The beacon signal may include certain information about the UV, for example, a unique identifier for the UV. Other information may also be included in the beacon signal, for example location information corresponding to the UV. Next, at 915, the user system processes the beacon signal to calculate a distance between the UA and the user system. In one aspect, the user system may process a plurality of beacon signals to calculate the distance between the UA and the user system. Alternatively, the user system may obtain location information about the UA from the beacon signal and use that information in combination with location information about the user system to calculate the distance between the UA and the user system.

At 920, the user system analyzes the distance between the UA and the user system to determine if the distance exceeds a threshold value. For example, the user system may have established a perimeter sphere based on a radius value from a center point defined by the location of the user system. If the UA is wholly or partially within the perimeter sphere, the user system may determine that the UA has exceeded the threshold value. If the user system determines at 920 that the UA has not exceeded the threshold distance value, the process loops back where the user system receives a subsequent beacon signal from the UV.

However, if the user system determines at 920 that the UA has exceeded the threshold value, at 925 the user system parses the beacon signal to identify the UV. Next, the user system initiates sending a proximity warning message to the UV. In one aspect, the user system, at 930, may optionally initiate sending of the proximity warning message directly to the UV, for example by way of a direct wireless communication. Alternatively, the user system, at 935, may optionally initiate sending of the proximity warning message indirectly to the UV, for example by way of a communication to a server or a satellite that, in turn, sends the proximity warning message to the UV.

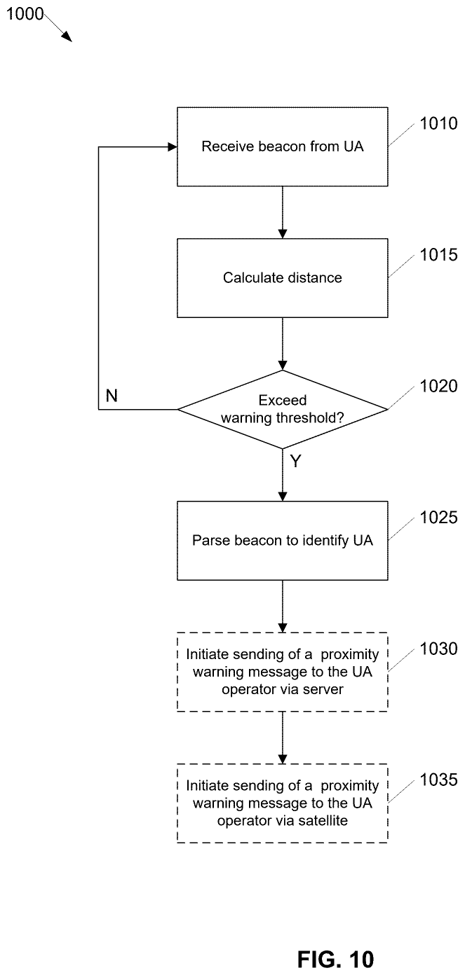

FIG. 10 is a flow diagram illustrating an example process 1000 for communicating with an operator of a UA according to an embodiment of the invention. In one aspect, the process of FIG. 10 may be carried out by the system described with respect to FIG. 2, 6, or 7 in combination with one or more processing devices described with respect to FIG. 3, for example, the process 1000 may be carried out by an application 232 executing on a user system 230 in combination with an application 212 executing on a platform 210.

Initially, at 1010, the user system receives a beacon signal being broadcast by the UV. The beacon signal may include certain information about the UV, for example, a unique identifier for the UV. Other information may also be included in the beacon signal, for example location information corresponding to the UV. Next, at 1015, the user system processes the beacon signal to calculate a distance between the UA and the user system. In one aspect, the user system may process a plurality of beacon signals to calculate the distance between the UA and the user system. Alternatively, the user system may obtain location information about the UA from the beacon signal and use that information in combination with location information about the user system to calculate the distance between the UA and the user system.

At 1020, the user system analyzes the distance between the UA and the user system to determine if the distance exceeds a threshold value. For example, the user system may have established a perimeter sphere based on a radius value from a center point defined by the location of the user system. If the UA is wholly or partially within the perimeter sphere, the user system may determine that the UA has exceeded the threshold value. If the user system determines at 1020 that the UA has not exceeded the threshold distance value, the process loops back where the user system receives a subsequent beacon signal from the UV.

However, if the user system determines at 1020 that the UA has exceeded the threshold value, at 1025 the user system parses the beacon signal to identify the UV. Next, the user system initiates sending a proximity warning message to the operator of the UV. In one aspect, the user system, at 1030, may optionally initiate sending of the proximity warning message to the operator of the UA via a server that is communicatively coupled with the user system via one or more networks and also communicatively coupled with the user system of the operator via one or more networks. For example, the one or more networks used by the server may include the Internet and involve one or more public or private networks. Alternatively, the user system, at 1035, may optionally initiate sending of the proximity warning message to the operator of the UA via a satellite that is communicatively coupled with the user system directly or via one or more networks and also communicatively coupled with the user system of the operator directly or via one or more networks. In one aspect, the one or more networks used by the satellite may include the Internet and involve one or more public or private networks.

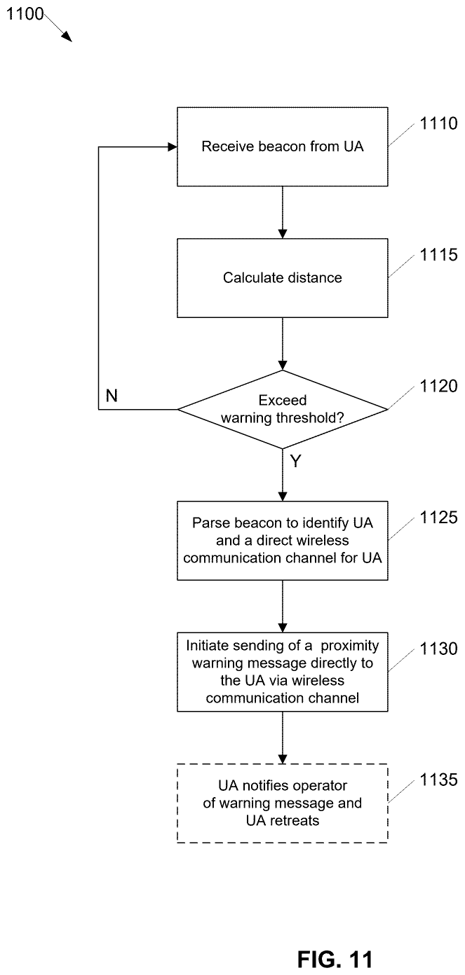

FIG. 11 is a flow diagram illustrating an example process 1100 for communicating directly with a UA according to an embodiment of the invention. In one aspect, the process of FIG. 11 may be carried out by the system described with respect to FIG. 2, 6, or 7 in combination with one or more processing devices described with respect to FIG. 3, for example, the process 1100 may be carried out at least in part by an application 232 executing on a user system 230.

Initially, at 1110, the user system receives a beacon signal being broadcast by the UV. The beacon signal may include certain information about the UV, for example, a unique identifier for the UV. Other information may also be included in the beacon signal, for example location information corresponding to the UV. In one aspect, the beacon signal that is periodically (e.g., 10 times per second or 10 times per minute) broadcast by the UA may also include contact information for the UA and/or the operator of the UA. In one aspect, contact information for the UA may include identification of a wireless communication channel that may be used to send a message directly to the UA. Advantageously, any user system that receives the beacon signal broadcast by the UA can employ an application (e.g., application 232) to parse the beacon signal to determine a direct wireless communication channel to the UA.

Next, at 1115, the user system processes the beacon signal to calculate a distance between the UA and the user system. In one aspect, the user system may process a plurality of beacon signals to calculate the distance between the UA and the user system. Alternatively, the user system may obtain location information about the UA from the beacon signal and use that information in combination with location information about the user system to calculate the distance between the UA and the user system.

At 1120, the user system analyzes the distance between the UA and the user system to determine if the distance exceeds a threshold value. For example, the user system may have established a perimeter sphere based on a radius value from a center point defined by the location of the user system. If the UA is wholly or partially within the perimeter sphere, the user system may determine that the UA has exceeded the threshold value. If the user system determines at 1120 that the UA has not exceeded the threshold distance value, the process loops back where the user system receives a subsequent beacon signal from the UV.

However, if the user system determines at 1120 that the UA has exceeded the threshold value, at 1125 the user system parses the beacon signal to identify the UA and to identify a direct wireless communication channel that can be used to send a message directly to the UA. Next, at 1130, the user system initiates sending a proximity warning message directly to the UA using the wireless communication channel. In some aspects, the direct wireless communication channel can be carried out using Bluetooth®, WiFi Direct®, BLE, Zigbee, Z-Wave, NFC, conventional WiFi, and many other short distance wireless communication technologies. After the direct wireless communication proximity warning message has been sent to the UA, at 1135 the UA optionally notifies the operator of the UA that the proximity warning message has been received and the UA may also optionally retreat. In one aspect, the UA maintains a “no fly zone” map in memory and the UA may update its “no fly zone” map and retreat or the UA may simply just retreat until such time that it has not received a proximity warning message for a predetermined amount of time.

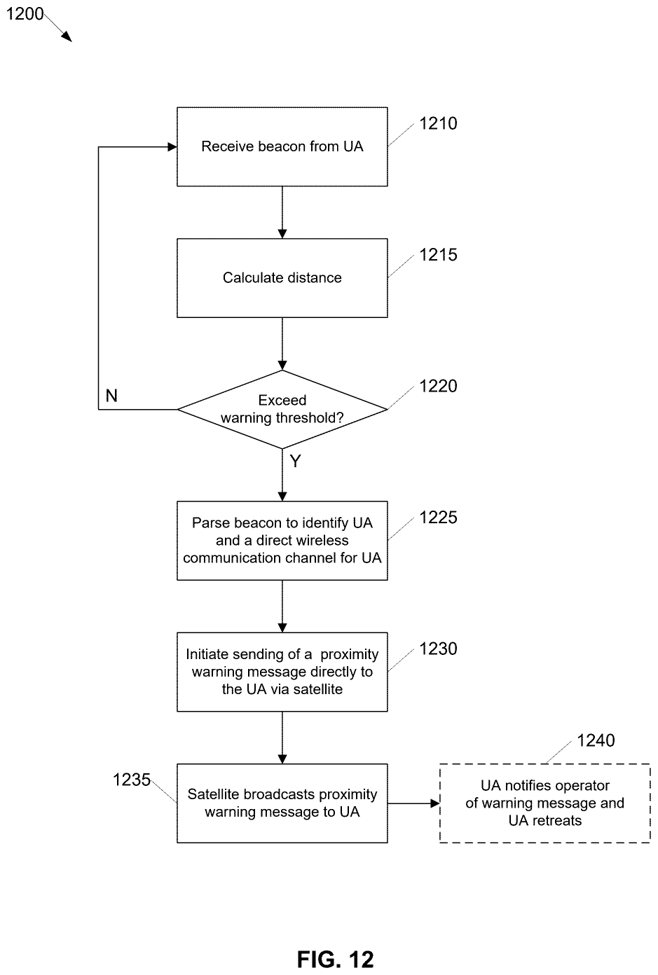

FIG. 12 is a flow diagram illustrating an example process 1200 for communicating directly with a UA according to an embodiment of the invention. In one aspect, the process of FIG. 12 may be carried out by the system described with respect to FIG. 2, 6, or 7 in combination with one or more processing devices described with respect to FIG. 3, for example, the process 1200 may be carried out by an application 232 executing on a user system 230.

Initially, at 1210, the user system receives a beacon signal being broadcast by the UV. The beacon signal may include certain information about the UV, for example, a unique identifier for the UV. Other information may also be included in the beacon signal, for example location information corresponding to the UV. In one aspect, the beacon signal that is periodically (e.g., 10 times per second or 10 times per minute) broadcast by the UA may also include contact information for the UA and/or the operator of the UA. In one aspect, contact information for the UA may include identification of a wireless communication channel that may be used to send a message directly to the UA. In another aspect, contact information for the UA may include identification of a satellite communication channel that the UA monitors to receive air traffic control information and other messages and information. Advantageously, any user system that receives the beacon signal broadcast by the UA can employ an application (e.g., application 232) to parse the beacon signal to determine the satellite communication channel being monitored by the UA.

Next, at 1215, the user system processes the beacon signal to calculate a distance between the UA and the user system. In one aspect, the user system may process a plurality of beacon signals to calculate the distance between the UA and the user system. Alternatively, the user system may obtain location information about the UA from the beacon signal and use that information in combination with location information about the user system to calculate the distance between the UA and the user system.

At 1220, the user system analyzes the distance between the UA and the user system to determine if the distance exceeds a threshold value. For example, the user system may have established a perimeter sphere based on a radius value from a center point defined by the location of the user system. If the UA is wholly or partially within the perimeter sphere, the user system may determine that the UA has exceeded the threshold value. If the user system determines at 1220 that the UA has not exceeded the threshold distance value, the process loops back where the user system receives a subsequent beacon signal from the UV.

However, if the user system determines at 1220 that the UA has exceeded the threshold value, at 1225 the user system parses the beacon signal to identify the UA and to identify the satellite communication channel that is being monitored by the UA. Next, at 1230, the user system initiates sending a proximity warning message to the UA via the satellite communication channel. In one aspect, the user system is communicatively coupled directly with the satellite or coupled indirectly via one or more networks, which may include the Internet and involve one or more public or private networks. The user system sends a message to the satellite comprising the unique identifier for the UA, the satellite communication channel being monitored by the UA, and location information for the user system to which the UA is in close proximity.

Next, at 1235, the satellite broadcasts the proximity warning message to the geographic region surrounding the location of the user system. The proximity warning message is broadcast on the same satellite communication channel that is being monitored by the UA and includes the unique identifier for the UA. Upon receipt of the proximity warning message via the satellite communication channel, the UA identifies its own unique identifier and determines that the message is directed to the UA.

After the proximity warning message from the satellite has been received by the UA, at 1240 the UA optionally notifies the operator of the UA that the proximity warning message has been received and the UA may also optionally retreat. In one aspect, the UA maintains a “no fly zone” map in memory and the UA may update its “no fly zone” map and retreat or the UA may simply just retreat until such time that it has not received a proximity warning message for a predetermined amount of time.

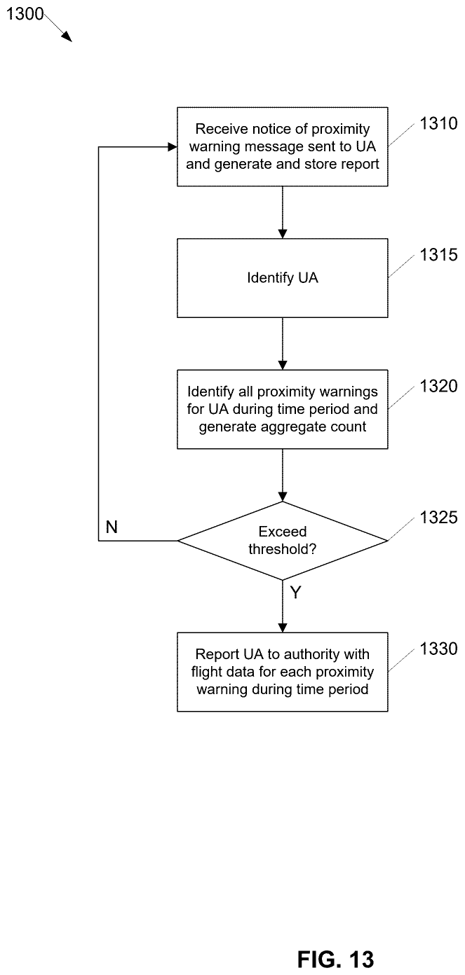

FIG. 13 is a flow diagram illustrating an example process 1300 for reporting flight data corresponding to a UA according to an embodiment of the invention. In one aspect, the process of FIG. 13 may be carried out by the system described with respect to FIG. 2, 6, or 7 in combination with one or more processing devices described with respect to FIG. 3, for example, the process 1300 may be carried out by an application 232 executing on a user system 230 in combination with an application 212 executing on a platform 210.

Initially, at 1310 the platform receives a notice of a proximity warning message that has been sent to a UA and the platform generates and stores a report of the proximity warning message in memory. The proximity warning message may have been sent to the UA directly or indirectly, e.g., via direct wireless, via satellite, via a network server, and the like. The proximity warning message may have also been sent to the UA via the operator of the UA. Advantageously, in all situations where a proximity warning message is sent to a UA, the platform receives a report that the proximity warning message was sent to the UA and stores a record of the proximity warning report in memory. The proximity warning report stored in memory by the platform includes the unique identifier for the UA and additional information such as date and time that the proximity warning message was generated and delivered to the UA, the user system that made the report, the location of the user system that made the report, how the proximity warning message was delivered to the UA, whether the proximity warning message was delivered to the operator of the UA or the user system of the operator of the UA, and other information surrounding the creation of the proximity warning message and the delivery of the proximity warning message.

After the proximity warning report is stored in memory, at 1315 the platform identifies the UA involved in the proximity warning report and at 1320 the platform searches its memory for all proximity warning reports involving the same UA during a certain time period. For example, the time period may be 30 minutes, 6 hours, 12 hours, 18 hours, 24 hours, 48 hours, 7 days, 14 days, 21 days, 30 days, or some other time period. Once all of the proximity warning reports involving the same UA during the time period have been identified, the total number of reports during the time period is determined. In one aspect, the platform may determine the total number of reports during each of a plurality of time periods.

Next, at 1325 the platform compares the total number of reports during a particular time period to a predetermined threshold for the time period. For example, a threshold for 30 minutes may be 3 reports, a threshold for 6 hours may be 10 reports, and a threshold for 30 days may be 30 reports. If the total number of reports for a time period exceeds the predetermined threshold, at 1330, the platform generates a report identifying the UA and sends the report to a UA flight authority. In one aspect, the report may include all of the known flight data for the UA. For example, the report to the UA flight authority may include all of the detailed information that is stored in each of the proximity warning reports that are stored in memory at the platform. In one aspect, the report to the UA flight authority is a concatenation of each of the proximity warning reports that are stored in memory at the platform for the particular UA.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system comprising at least one processor communicatively coupled with at least one non-transitory computer readable medium, wherein the at least one processor is programmed to:
receive a wireless communication signal from an unmanned aircraft (UA);
parse the wireless communication signal to obtain an identifier corresponding to the UA;
use the identifier to determine an operator of the UA;
obtain contact information for the operator of the UA; and
send a message to the operator of the UA.

2. The system of claim 1, wherein the message is sent directly to the operator of the UA.

3. The system of claim 1, wherein the message is sent indirectly to the operator of the UA.

4. The system of claim 3, wherein the message is sent indirectly to the operator of the UA via a server.

5. The system of claim 3, wherein the message is sent indirectly to the operator of the UA via a satellite.

6. The system of claim 1, wherein the at least one processor is programmed to perform further steps comprising:
calculate a distance to the UA based on the received wireless signal;
determine whether the calculated distance exceeds a predetermined threshold; and
when the calculated distance exceeds the predetermined threshold, send a proximity warning message to the operator of the UA.

7. The system of claim 6, wherein the proximity warning message is sent directly to the operator of the UA.

8. The system of claim 6, wherein the proximity warning message is sent indirectly to the operator of the UA.

9. The system of claim 8, wherein the message is sent indirectly to the operator of the UA via a server.

10. The system of claim 8, wherein the message is sent indirectly to the operator of the UA via a satellite.

11. A method where one or more processors are programmed to perform steps comprising:
receive a wireless communication signal from an unmanned aircraft (UA);
calculate a distance to the UA based on the received wireless communication signal;
determine that the calculated distance exceeds a predetermined threshold;
parse the wireless communication signal to identify a wireless communication channel corresponding to the UA; and
send a proximity warning message to the UA via the wireless communication channel.

12. The method of claim 11, wherein the UA relays the proximity warning message to the operator of the UA.

13. The method of claim 11, wherein the proximity warning message is sent directly to the UA.

14. The method of claim 11, wherein the proximity warning message is sent indirectly to the UA.

15. The method of claim 14, wherein the proximity warning message is sent indirectly to the UA via a server.

16. The method of claim 14, wherein the proximity warning message is sent indirectly to the UA via a satellite.

17. The method of claim 16, wherein the satellite broadcasts the proximity warning message to the UA.

18. A method where one or more processors are programmed to perform steps comprising:
present a user interface on a user device;
receive an input via the user interface, the input corresponding to a distance;
calculate a perimeter of a region surrounding the user device based on the input; and
periodically broadcast a wireless communication identifying the perimeter of the region.

19. The method of claim 18, wherein the region is substantially spherical.

20. The method of claim 18, wherein the region is substantially polygonal.

21. The method of claim 18, wherein the region has a base comprising a surface of the earth and extends upward from the base.

22. A system comprising:
a user device comprising:
a wireless receiver configured to receive wireless communication signals from an unmanned aircraft (UA) in proximity to the user device;
a non-transitory computer readable medium configured to store executable programmed modules; and
a processor communicatively coupled with the wireless receiver and the non-transitory computer readable medium, the processor configured to execute one or more programmed modules stored in the non-transitory computer readable medium to:
process a signal from the UA received by the wireless receiver to identify the UA;
identify an operator corresponding to the UA; and
send a message to the operator of the UA; and
a server device comprising:
a non-transitory computer readable medium configured to store executable programmed modules; and
a processor communicatively coupled with the non-transitory computer readable medium, the processor configured to execute one or more programmed modules stored in the non-transitory computer readable medium to:
process a signal received from the user device;
identify an operator corresponding to the UA; and
send a message to the operator of the UA.

23. The system of claim 22, wherein the user device processor is further configured to send the message directly to the operator of the UA.

24. The system of claim 22, wherein user device processor is further configured to send the message indirectly to the operator of the UA.

25. The system of claim 24, wherein the message is sent indirectly to the operator of the UA via a satellite.

26. The system of claim 24, wherein the message is sent indirectly to the operator of the UA via the server.

27. The system of claim 22, wherein the user device processor is further configured to:
calculate a distance to the UA based on the received wireless signal;
determine whether the calculated distance exceeds a predetermined threshold; and
when the calculated distance exceeds the predetermined threshold, send a proximity warning message to the operator of the UA.

28. The system of claim 27, wherein the proximity warning message is sent directly or indirectly to the operator of the UA.

29. The system of claim 28, wherein the proximity warning message is sent indirectly to the operator of the UA via a satellite.

30. The system of claim 28, wherein the proximity warning message is sent indirectly to the operator of the UA via the server.
